(19) United States
(12) Patent Application Publication
(10) Pub. No.: US 2022/0238091 A1
(43) Pub. Date: Jul. 28, 2022

(54) SELECTIVE NOISE CANCELLATION

(71) Applicant: Dell Products L.P., Round Rock, TX (US)

(72) Inventors: Fnu Jasleen, Austin, TX (US); Rocco Ancona, San Jose, CA (US); Glen E. Robson, Austin, TX (US)

(73) Assignee: Dell Products L.P., Round Rock, TX (US)

(21) Appl. No.: 17/159,664

(22) Filed: Jan. 27, 2021

(51) Int. Cl. G10K 11/178; G06F 9/451

(52) U.S. Cl. CPC G10K 11/178; H04N 7/15; G06F 9/451

(57) ABSTRACT

An information handling system presents audio information as audible sounds that include noise cancellation generated in response to environmental noise patterns detected by a microphone. For example, a machine learning model generates noise cancellation for plural environmental noise patterns, such as a baby crying, a dog barking, and a door bell ringing. The noise cancellation engine selectively applies and disables one or more types noise cancellation with the model based upon context at the information handling system, such as an application running on the system, a time of day or other factors.

### BACKGROUND OF THE INVENTION

### Field of the Invention

The present invention relates in general to the field of information handling system audible information presentation, and more particularly to an information handling system selective noise cancellation.

### Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems often present audio information at speakers, both in cooperation with visual information and as a separate output. For instance, audio information often accompanies visual information in applications like movie players, videoconferencing, and gaming. In some instances, audio information is presented without visual images, such as music players and audio conferences. Contemporary information handling systems generally have sufficient processing capability to simultaneously play music and perform complex computational tasks. End users will often work with entertainment applications playing in the background, such as music, to drown out background noise distractions. This practice has likely grown more common as an increasing number of employees have begun working from home, where distractions from children, pets, neighbors and life generally can make concentration on work tasks more difficult.

One option available to reduce the impact of background noise on work productivity is to use headphones that include active noise cancellation. Active noise cancellation seeks to eliminate background noise by generating sounds at the headphone that are out of phase background noise. As an example, a microphone captures the background hum of a home heater or air conditioner and includes sounds output at the headphones that have an inverse pressure of the background sounds, effectively cancelling the background sounds. Active noise cancellation works particularly well with low frequency and consistent background noise that low power processors can adapt to manage, such as airplane noise or car noise. In a videoconference application, noise cancellation may be used to also cancel noise captured by a microphone before audible sounds are sent through a network to other participants and to cancel background noise capture at other nodes of the videoconference. Active noise cancellation has more difficulty with irregular and high pitch sounds, such as a doorbell ringing, a dog barking or a baby crying. Effective cancellation of these types of noises take more processing power and audio models directed towards the specific noise of interest. As such active noise cancellation headphones have improved, end users have benefited by reduced distractions and improved ability to concentrate so that many ordinary household sounds have become indiscernible once the end user places the headphones over her ears.

### SUMMARY OF THE INVENTION

Therefore, a need has arisen for a system and method which selectively applies noise cancellation for an end user based upon end user context and preferences.

In accordance with the present invention, a system and method are provided which substantially reduce the disadvantages and problems associated with previous methods and systems for managing active noise cancellation. Noise cancellation is selectively applied for detected environmental noise based upon a context at an information handling system, such as applications executing on the information handling system and end user preferences stored based upon a type of detected environmental noise.

More specifically, a noise cancellation engine generates audible noise to play in headphone speakers that cancel out sound waves of environmental noise. For example, a machine learning derived model associated with plural types of noise is selectively applied or not applied when associated noise is detected based upon a context at the information handling system. An end user provides preferences for whether or not to apply noise cancellation so that the end user can balance a desire for quiet to concentrate, such as when performing a work task, with a need to monitor environmental conditions, such as when in a home environment where a child can get hurt or a visitor may come to the door. End users are provided with a notice of noise types when first detected or when detected at a low threshold of confidence so that the end user can provide a confirmation of how to manage noise cancellation related to the noise in different contexts. Noise cancellation data is stored for analysis to help more efficiently target different noise types and then applied to the headphone speakers as indicated by the end user's configuration preferences. Visual or audible alerts of detected noise may be provide to the end user when noise cancellation is enforced for a type of noise.

The present invention provides a number of important technical advantages. One example of an important technical advantage is that an end user has noise cancellation selectively applied in a manner that enhances the mixed demands of a work-from-home situation. Noise cancellation is provided based upon multiple factors derived as a combination of the user's environment, such as noise of a baby crying, a dog barking, a doorbell ringing, etc . . . , and data from the system, such as applications executing, interactions associated with work or personal matters, end user presentation to others at the system, the system on mute and the system volume setting. The data and noise cancellation types are monitored to selectively apply noise cancelling for different types of noise based upon context, such as with a Recurrent Neural Network (RNN) that provides noise cancellation when the type of noise and context indicate a minimum confidence. A self-improving machine learning model applies the end user's preference and stored conditions to improve the noise cancellation application over time, such as by setting a threshold associated with the confidence that detected noise and context fall in a particular state that calls for noise cancellation by the model.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts a block diagram of an information handling system configured to selectively enable and disable noise cancellation associated with playing of audible information based upon a context at the information handling system;

FIG. 2 depicts an example of an end user having headphone speakers that selectively cancel different noise types based upon system context;

FIG. 3 depicts a flow diagram of a process for managing selective noise cancellation based upon information handling system context; and

FIG. 4 depicts a functional block diagram of a noise cancellation system that selectively applies and removes from application noise cancellation based upon the type of noise detected and the system context.

### DETAILED DESCRIPTION

Noise cancellation of various background noise is selectively enabled and disabled at an information handling system based upon context. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

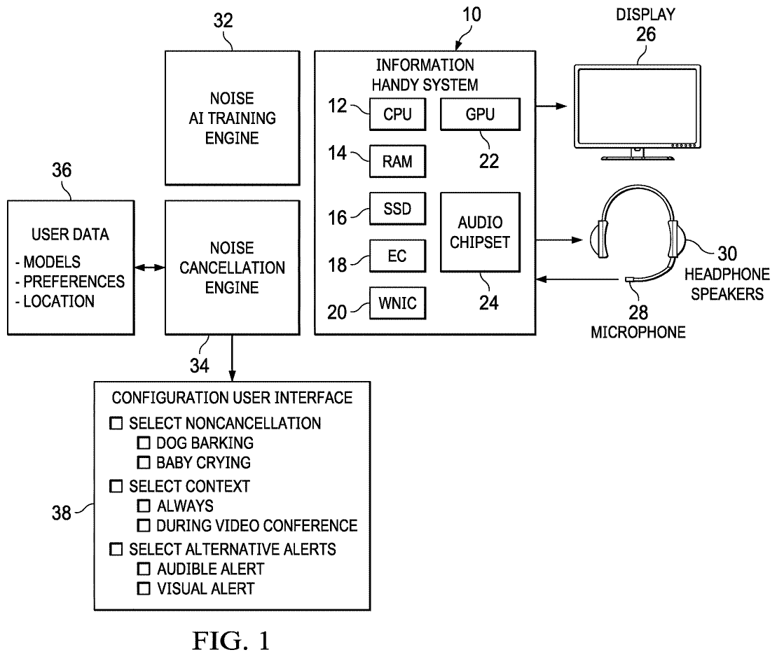

Referring now to FIG. 1, a block diagram depicts an information handling system 10 configured to selectively enable and disable noise cancellation associated with playing of audible information based upon a context at the information handling system. Information handling system 10 includes a central processing unit (CPU) 12 that executes instructions to process information. CPU 12 interfaces with a random access memory (RAM) 14 that stores the instructions and information accessible to CPU 12. A solid state drive (SSD) 16 provides persistent storage during power down of the system, such as with flash memory or other types of non-transitory memory. For example, at system power up an embedded controller 18 executes pre-boot code that retrieves a BIOS and operating system from SSD 16 to RAM 14 for execution by CPU 12. Embedded controller 18 provides additional functionality, such as power management, interfacing with input devices and managing interactions of components on a physical level. A wireless network interface card (WNIC) 20 provides wireless communication with external devices, such as wireless local area networks (WLAN) and wireless personal area networks (WPNA) like Bluetooth. A graphics processing unit (GPU) 22 interfaces with CPU 12 to process the information to generate visual images, such as with pixel values that are communicated to display 26 for presentation as visual images. An audio chipset 24 interfaces with CPU 12 to process audio information for presentation as audible sounds at headphone speakers 30 and to receive audio input from microphone 28 to communication to CPU 12.

In a typical workday, end users interact with information handling system 10 through a variety of different applications that perform a variety of different functions, each of which call for varying degrees and types of concentration from the end user. For example, an engineer may run a computer aided design (CAD) application or software design editor to perform a primary job duty of designing mechanical or software components. While performing these types of functions, the end user typically desires quiet for concentration to perform tasks that call for deep thought. Throughout the workday, the end user may also meet with members of her design team through a videoconference that presents the team and shared data at display 26 and supports conversations through headphone speakers 30. At other times during the workday, the end user may perform more mundane daily tasks, such as reading emails and performing administrative tasks. In addition to such work related interactions, end users may also interact with the information handling system through applications that provide non-work functions including entertainment. For instance, an end user may browse the Internet with a web browser or execute an audiovisual player application to watch a movie. Some end users find it helpful to concentration to listen to music while performing work tasks. In particular, as is described in greater detail below, end users often use noise cancellation headphone speakers 30 during work tasks to play audio of quiet music while blocking background noise that can distract the end user. Conventional noise cancellation, however, can block out background noises in a work-from-home environment that an end user may need to hear, such as a baby crying that needs attention, a doorbell or dog barking that indicates a home visitor or other common home background noises.

To help manage noise cancellation in the work-from-home environment, a noise cancellation engine 34 selectively enables and disables noise cancellation based upon a context at the information handling system. For example, noise cancellation engine 34 generates out of phase audio information that creates sounds at speaker headphones 30 to cancel background noise as the background noise is sensed at microphone 28. For instance, microphone 28 captures environmental noise and provides the environmental noise to noise cancellation engine 34. Noise cancellation engine 34 references user data 36 to determine types of noise cancellation for application to cancel environmental noise based upon context determined from end user preferences and other information, such as system location and time of day. In one example embodiment, noise cancellation engine executes a noise cancellation model developed with a Recurrent Neural Network (RNN) that selectively cancels different types of environmental noise, such as a baby crying or dog barking, and generates cancellation noises to play in headphone speakers 30 that cancels out the associated background noise. If the context indicates that noise cancellation should be applied, noise cancellation engine 34 generates the cancelling noise output for presentation at headphone speakers 30. If the context indicates that noise cancellation is not desired, noise cancellation engine 34 does not apply noised cancellation for that background environmental noise. Although the particular noise cancellation may not be applied, other background noises may be cancelled based upon the context and user preferences. For instance, noise cancellation engine 34 might cancel out a doorbell while ignoring background environmental noise that matches a baby crying.

Whether or not a particular background noise is cancelled, the background noise and context may be provided to a noise artificial intelligence or machine learning engine 32, which evaluates the data to improve recognition and cancellation of noise by noise cancellation engine 34. In various embodiments, noise cancellation engine 34 may be supported across various hardware elements. For example, noise cancellation engine 34 may distribute executables to processing elements located in headphone speakers 30 so that noise cancellation is applied in a rapid manner when background noise is picked up microphones 28 integrated with headphone speakers 30. A user interface manager of noise cancellation engine 34 then selectively activates and deactivates selected of plural noise cancellation types executing on processing elements of headphone speakers 30 with commands communicated through audio chipset 24 and WNIC 20. For example, operating system drivers may be used to manage selection and de-selection of noise cancellation on headphone speaker processing resources as noise cancellation engine 34 detects changes in context. Generally, logic of the noise cancellation engine listens to environmental noise and monitors context at the system to determine for detected background noise whether or not to generate noise cancellation with degree of confidence. If cancellation is determined within a defined threshold, such as 80%, noise cancellation is generated at the headphone speakers. If cancellation is determined with less than the threshold, an inquiry to an end user may be made to help define if noise cancellation should take place and thereby train the noise cancellation model.

In the example embodiment, noise cancellation engine 34 presents a configuration user interface 38 that aids end user inputs to define context for selective application and removal of application of noise cancellation. For instance, when noise cancellation engine 34 detects a noise pattern associated with a particular background noise, such as a baby crying, that is not in user data 36, noise cancellation engine 34 presents configuration user interface 38 to accept end user inputs regarding the preferred manner for managing the background noise. In the example user interface, the end user is provided with a list of detected background noises and an opportunity to configure how noise cancellation is applied for each type of background noise. For example, the end user may select non-cancellation of dog barking while cancelling baby crying or vice versa. For each type of background noise, the end user may select specific contexts in which to apply and not apply noise cancellation. For instance, when a videoconference application is active on the system, the user may accept background noise from a baby crying so that the user can respond to the baby while cancelling noise from a dog barking so that the videoconference is not interrupted. The end user may also set other context, such as cancellation preferences based upon time of day, location, and/or other types of applications executing on the system, like audiovisual player applications that play entertainment versus work content, web browsing applications, email applications, CAD applications or other types of applications. In the example embodiment, an end user is also provided with an opportunity to select alternative alerts, such as an audible alert or a visual alert. For instance, if a noise type, like a baby crying, has noise cancellation active, the end user may elect to receive a visual alert, such as at the display, or an audio alert, such as a spoken voice or a tone, to let the end user know that the cancelled noise is detected. In some instances, the end user may elect to have such alerts posted for non-cancelled noise so that a muffled noise that may be difficult to detect under earphones will be temporarily highlighted.

Noise cancellation configuration user interface 38 may come up to display 26 automatically when a new background noise type is detected so that the end user can provide a preference for managing the new type of noise. Alternatively, an end user may activate configuration user interface 38 at any time to adjust user data 36 for a desired noise cancellation response. In another embodiment, the presentation of noise cancellation configuration user interface may be based upon a confidence that a detected background noise falls within a type of noise modeled for cancellation. For instance, if a dog barking is detected with a very low confidence of below a threshold, the end user may be asked to confirm that type of noise is of interest for cancellation. As another example, if the dog barking type of noise is detected with a high confidence of above a threshold but for a first incidence, the end user may be asked to confirm that the noise is one that the end user has an interest in cancelling. In some instances, all background noises are selectively canceled when threshold confidence is met, whether or not the type of noise is recognized.

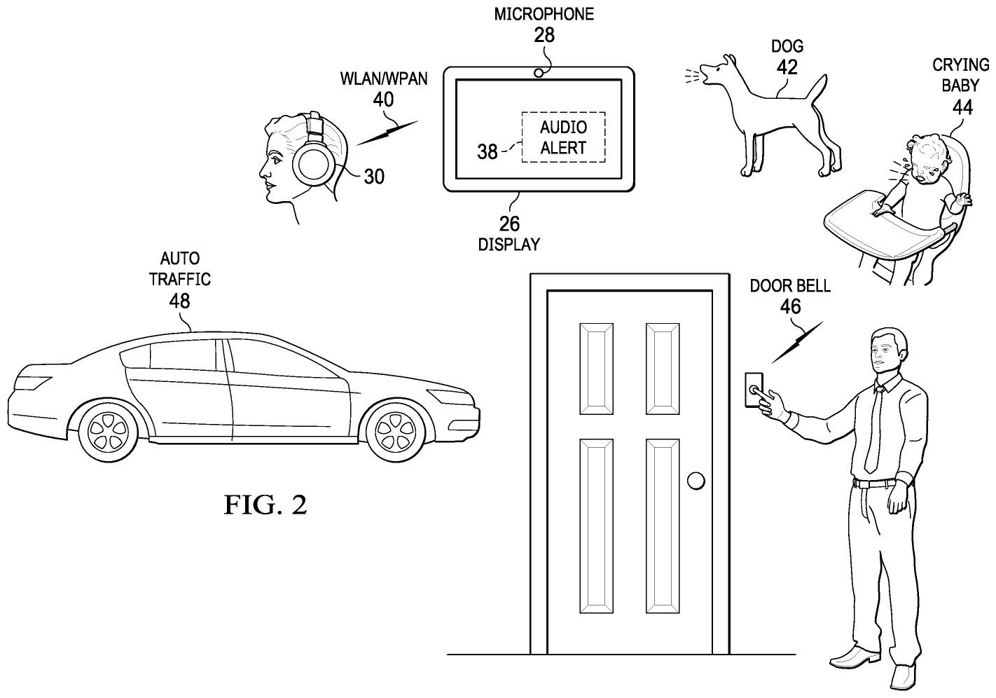

Referring now to FIG. 2, an example depicts an end user having headphone speakers 30 that selectively cancel different noise types based upon system context. In the example embodiment, headphone speakers 30 receive audio information from an information handling system through a wireless interface 40, such as WLAN or WPAN like Bluetooth, and associated with presentation of visual images at display 26. Noise cancellation of the model is selectively activated and deactivated with commands communicated through wireless interface 40 to processing resources integrated in headphone speakers 30. A microphone 30 captures background noise for analysis by the information handling system to detect the different types of background noises. Note, in one embodiment, microphone 28 may be integrated in headphone speakers 30 to communicate captured background noise to the information handling system through wireless interface 40 while simultaneously using the captured noise locally to support an active noise cancellation model. Around the end user, examples of modeled background noise include a dog 42 barking, a baby 44 crying, a doorbell 46 ringing and auto 48 traffic. An audio alert 38 is presented at display 26 when configured conditions are met, such as activation of noise cancellation for one or more of the detected background sounds. As is described above, the end user can configure each of these noise types for application or removal of noise cancellation by headphone speakers 30 based upon sensed context, such as the type of application executing on the information handling system or the time of day. For example, dog barking may be cancelled during the workday and not cancelled after the workday; the baby crying may have cancellation during the use of all work applications and not cancelled from 11 to 1 when the end user has a sitter on lunch break or all day when the end user is watching entertainment with an audiovisual player application. A doorbell may be canceled only during videoconference application execution but not cancelled at other times. The end user may manually set the desired configuration or the noise cancellation may apply default configuration settings until updated by the end user.

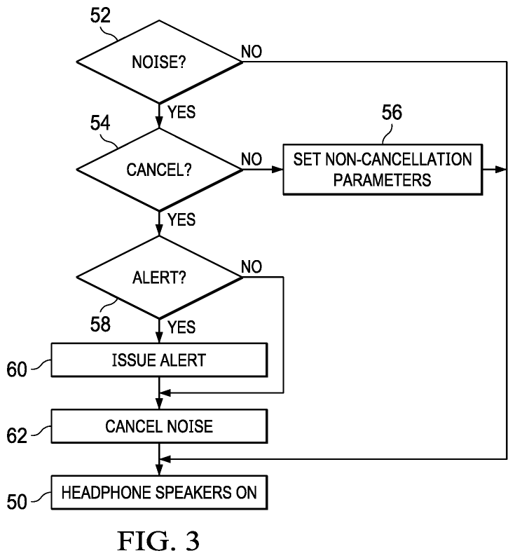

Referring now to FIG. 3, a flow diagram depicts a process for managing selective noise cancellation based upon information handling system context. The process starts at step 50 with power on of the headphone speakers. At step 52 a determination is made of whether environmental noise is detected that is of a type that matches noise cancellation available with the noise cancellation model. If not, the process returns to step 50 to continue monitoring for environmental noise. If noise is detected, the process continues to step 54 to determine whether the detected noise is configured for cancellation. If not, the process continues to step 56 to set a non-cancellation parameter in the configuration and the process returns to step 50 to continue monitoring for environmental noise. If cancellation is set at step 54 for the type of detected noise, the process continues to step 58 to determine if an audio or video alert should issue to the end user about the detected noise since the end user's ability to hear the noise is decreased by noise cancellation. If not, the process continues to step 62 to cancel the noise and then to step 50 to continue monitoring for other types of noise. If an alert is configured, the process continues to step 60 to issue the alert and then step 62 to cancel the noise. The alert may be an audio or visual indication to the end user of the cancelled noise, such as dog icon or crying baby icon presented at the display or a spoken alert of the type of cancelled noise. In one embodiment, the cancelled noise may be stored and played back to the end user when an opportune time arises.

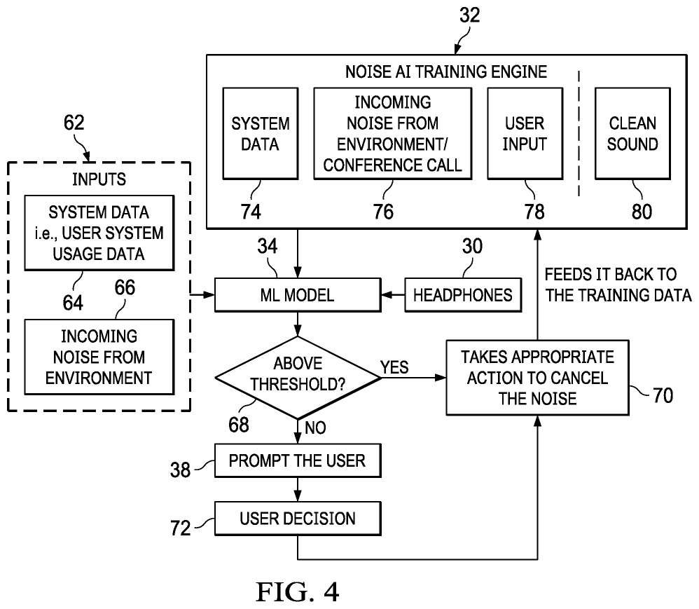

Referring now to FIG. 4, a functional block diagram depicts a noise cancellation system that selectively applies and removes from application noise cancellation based upon the type of noise detected and the system context. As described above, noise cancellation inputs 62 include system data, such as user system usage data that defines user preferences in relation to contexts, and incoming noise from the environment detected by a microphone. The noise cancellation inputs are provided to noise cancellation engine 34 where a model generated by machine learning or artificial intelligence is selectively applied to generate audio information that, when played, cancels the environmental noise detected by the microphone. The noise cancellation audio is determined in part by characteristics of headphone speakers 30, which may have varied presentation of audio to an end user based upon noise deadening. Once the environmental noise is discerned by the machine learning model a functional check is performed at logic 68 to determine if detected noise is over a threshold for cancellation. If the detected noise is over the threshold, logic at 68 continues to logic at 70 that initiates cancellation of the noise. If the noise is less than the threshold the logic continues to present at display 26 a prompt for the end user to indicated a preference to cancel or not cancel the noise. Once the user makes the input, logic at 70 applies noise cancellation according to the user's preference. Once noise cancellation is applied, the data associated with noise cancellation is provided to noise artificial intelligence training engine 32 to update the noise cancellation model and user preferences, such as through machine learning. In one example embodiment, the data is stored for analysis at a later time period or at an offline resource, such as a cloud location. The stored data may include the clean sound 80 generated by the cancellation, the user inputs 78 related to configuration in response to the noise, the detected noise itself and the related environment, such as a conference call or other activity, and system data recorded at the time of the noise detection. In one example embodiment, machine learning is applied to estimate end user preferences related to noise cancellation and to apply those preferences automatically.

Although the present invention has been described in detail, it should be understood that various changes, substitutions and alterations can be made hereto without departing from the spirit and scope of the invention as defined by the appended claims.

What is claimed is:

1. An information handling system comprising:
a processor operable to execute instructions to process information;
a memory interfaced with the processor and operable to store the instructions and the information;
a graphics processor operable to process the information to define visual images for presentation at a display;
an audio chipset operable to process the information to generate audible sounds;
a display interfaced with the graphics processor and operable to present the visual images;
a speaker interfaced with the audio chipset and operable to present the audible sounds;
a microphone operable to capture environmental sounds;
a noise cancellation engine interfaced with the speaker and the microphone, the noise cancellation engine operable to generate information for presentation as audible cancellation sounds at the speaker that cancel the environmental sounds, the noise cancellation engine having selective cancellation of plural environmental noise types; and
a noise cancellation configuration user interface presented at the display and operable to accept end user preferences that define predetermined conditions at which one or more of the noise cancellation plural environmental noise types are applied for cancellation or removed from application from cancellation at the noise cancellation engine.

2. The information handling system of claim 1 wherein the one or more of the noise cancellation plural environmental noise types comprises the environmental noise type of a baby crying.

3. The information handling system of claim 1 wherein the one or more of the noise cancellation plural environmental noise types comprises the environmental noise type of a dog barking.

4. The information handling system of claim 1 wherein the one or more of the noise cancellation plural environmental noise types comprises the environmental noise type of a doorbell ringing.

5. The information handling system of claim 1 wherein the noise cancellation configuration engine is further operable to present a visual indication of a noise type at the display when the predetermined conditions apply the noise cancellation.

6. The information handling system of claim 1 further comprising:
a noise cancellation training engine interfaced with the microphone and the noise cancellation engine and operable to detect plural predetermined environmental noise types, to define a noise cancellation associated with each detected environmental noise type at a confidence level;
wherein the noise cancellation configuration user interface presents an end user with a preference selection of whether to apply the defined noise cancellation when the confidence level meets a threshold.

7. The information handling system of claim 1 wherein the noise cancellation engine selectively applies or removes from application one or more of the noise cancellations based upon a context sensed at the information handling system.

8. The information handling system of claim 7 wherein the context comprises a videoconference presented at the display.

9. The information handling system of claim 7 wherein the context comprises audiovisual entertainment presented at the display.

10. A method for managing noise cancellation at an information handling system, the method comprising:
detecting a first noise pattern of environmental noise captured by a microphone;
detecting a context of the information handling system;
automatically applying noise cancellation for the first detected noise pattern at a first detected context; and
automatically removing from application noise cancellation for the first detected noise pattern at a second detected context.

11. The method of claim 10 further comprising:
detecting a second noise pattern of environmental noise captured by the microphone with a threshold confidence; and
presenting at the information handling system a user interface for end user confirmation of the application of noise cancellation of the second noise pattern.

12. The method of claim 10 further comprising:
presenting at the information handling system plural noise cancellation selections, each associated with a noise pattern of environmental noise;
presenting plural contexts at the information handling system;
accepting at least one preference for at least one of the plural noise cancellation selections to disable for at least one of the plural contexts; and
automatically removing from application noise cancellation for the at least one preference.

13. The method of claim 10 wherein the context comprises a time of day.

14. The method of claim 10 wherein the context comprises a videoconference application actively executing on the information handling system.

15. The method of claim 10 wherein the first detected noise pattern comprises a baby crying.

16. The method of claim 10 further comprising when applying the noise cancellation for the first detected noise pattern at the first detected context, presenting at a display of the information handling system a visual alert of the noise cancellation of the first detected noise pattern.

17. A system for managing audio noise cancellation, the system comprising:
one or more processors; and
a non-transient memory storing instructions that when executed on one or more of the processors:
detect a noise pattern of environment noise associated with a noise cancellation;
detect a first context;
in response to the first context, apply the noise cancellation to play audio at a speaker;
detect a second context; and
in response to the second context, play audio at the speaker without the noise cancellation.

18. The system of claim 17 wherein the first context comprises a videoconference application executing on one or more of the processors.

19. The system of claim 17 wherein the noise cancellation comprises cancellation of a noise pattern of a baby crying.

20. The system of claim 17 wherein the second context comprises an audiovisual entertainment application.
